(19) United States
(12) Patent Application Publication
(10) Pub. No.: US 2011/0010272 A1
(43) Pub. Date: Jan. 13, 2011

(54) Facilitating Simulated Purchases of Items by Virtual Representations of Participants in Computer-Based Simulations

(76) Inventor: Shmuel Ur, Shorashim (IL)

Correspondence Address: IBM CORPORATION, T.J. WATSON RESEARCH CENTER, P.O. BOX 218, YORKTOWN HEIGHTS, NY, 10598, US

(21) Appl. No.: 12/501,514

(22) Filed: Jul. 13, 2009

(51) Int. Cl. G06Q 30/00; G06F 3/048; G06F 15/16

(52) U.S. Cl. 705/27.2; 715/757; 709/206

(57) ABSTRACT

A method for facilitating simulated purchases by virtual representations of participants in computer-based simulations of items outside of the context of computer-based simulations, the method including receiving a simulated payment for an item for purchase, where the simulated payment is associated with a virtual representation of a participant in a computer-based simulation, where the item is available for purchase outside of the context of the simulation, and where the simulated payment is received outside of the context of the simulation, and providing a description of the item to a process of the simulation, where the description is provided subsequent to receiving the simulated payment, where and the description is provided in association with the virtual representation.

### FIELD OF THE INVENTION

The present invention relates in general to electronic commerce and computer gaming, and in particular to synthetic systems and methods therefor.

### BACKGROUND OF THE INVENTION

Creators of computer-based simulations, including computer-based games such as The Sims™, often seek to provide simulations of real-life experiences, such as where virtual representations of participants in computer-based simulations, known as “avatars,” are able to “purchase” simulated goods and services within the context of a computer-based simulation. Thus, an avatar may buy simulated clothing in simulated stores, simulated houses and other simulated properties, provided that the computer-based simulation in which the avatar exists provides such capabilities.

### SUMMARY OF EMBODIMENTS OF THE INVENTION

Embodiments of the present invention disclose systems and methods for providing a synthetic experience where an avatar in a computer-based simulation is able to interact with environments that are outside of the context of the computer-based simulation.

In one aspect of the present invention a method is provided for facilitating simulated purchases by virtual representations of participants in computer-based simulations of items outside of the context of computer-based simulations, the method including receiving a simulated payment for an item for purchase, where the simulated payment is associated with a virtual representation of a participant in a computer-based simulation, where the item is available for purchase outside of the context of the simulation, and where the simulated payment is received outside of the context of the simulation, and providing a description of the item to a process of the simulation, where the description is provided subsequent to receiving the simulated payment, where and the description is provided in association with the virtual representation.

In another aspect of the present invention a system is provided for facilitating simulated purchases by virtual representations of participants in computer-based simulations of items outside of the context of computer-based simulations, the system including simulated payment information for an item for purchase, where the simulated payment is associated with a virtual representation of a participant in a computer-based simulation, where the item is available for purchase outside of the context of the simulation, and where the simulated payment is received outside of the context of the simulation, a description of the item, where the description is provided subsequent to receiving the simulated payment, where and the description is provided in association with the virtual representation, and a computer configured to store the description, receive the simulated payment, and provide the description to a process of the simulation.

In another aspect of the present invention a computer program is provided embodied on a computer-readable medium, the computer program including a first code segment operative to receive a simulated payment for an item for purchase, where the simulated payment is associated with a virtual representation of a participant in a computer-based simulation, where the item is available for purchase outside of the context of the simulation, and where the simulated payment is received outside of the context of the simulation, and a second code segment operative to provide a description of the item to a process of the simulation, where the description is provided subsequent to receiving the simulated payment, where and the description is provided in association with the virtual representation.

### BRIEF DESCRIPTION OF THE DRAWINGS

Embodiments of the present invention will be understood and appreciated more fully from the following detailed description taken in conjunction with the appended drawings in which:

FIG. 1 is a simplified conceptual illustration of a system for facilitating simulated purchases by virtual representations of a participants in computer-based simulations of items outside of the context of computer-based simulations, constructed and operative in accordance with an embodiment of the present invention; and

FIG. 2 is a simplified flowchart illustration of an exemplary method of operation of the system of FIG. 1, operative in accordance with an embodiment of the present invention.

### DETAILED DESCRIPTION OF EMBODIMENTS OF THE INVENTION

The present invention is now described within the context of one or more embodiments, although the description is intended to be illustrative of the invention as a whole, and is not to be construed as limiting the invention to the embodiments shown. It is appreciated that various modifications may occur to those skilled in the art that, while not specifically shown herein, are nevertheless within the true spirit and scope of the invention.

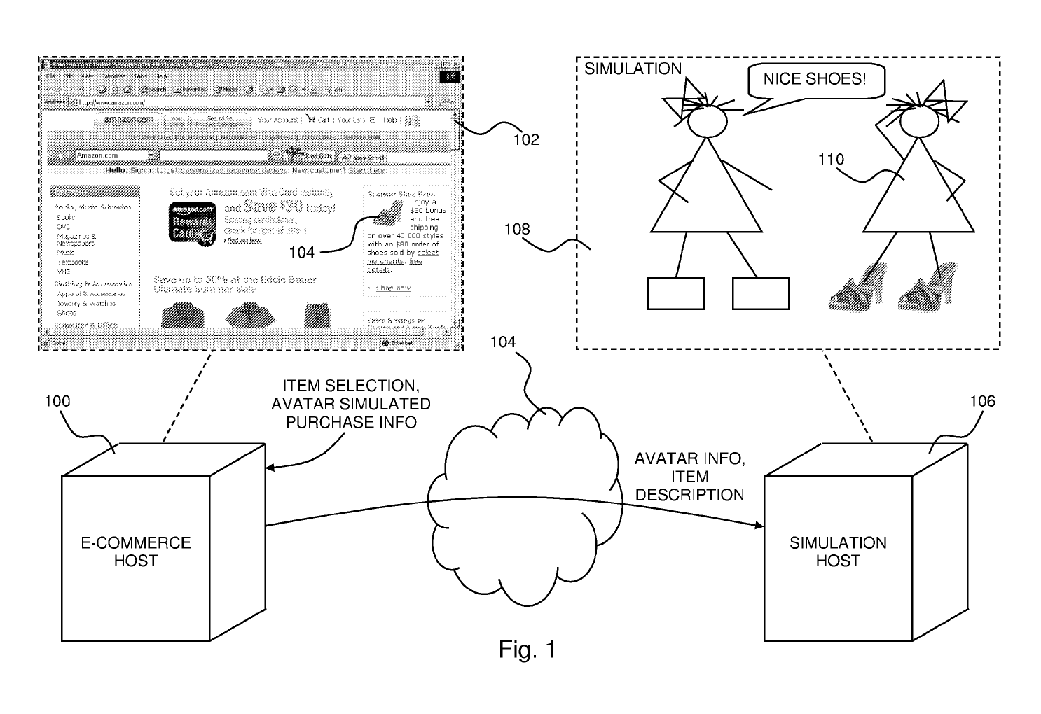

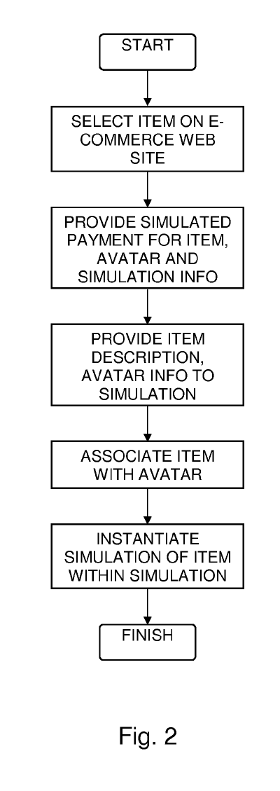

Reference is now made to FIG. 1, which is a simplified conceptual illustration of a system for facilitating simulated purchases by virtual representations of a participants in computer-based simulations of items outside of the context of computer-based simulations, constructed and operative in accordance with an embodiment of the present invention, and additionally to FIG. 2, which is a simplified flowchart illustration of an exemplary method of operation of the system of FIG. 1, operative in accordance with an embodiment of the present invention. In the system of FIG. 1 and method of FIG. 2, an electronic commerce (e-commerce) host computer 100 is shown hosting an e-commerce web site 102, such as amazon.com™, that offers various items for purchase, such as ladies' shoes 104. A simulation host 106 is also shown hosting a computer-based simulation 108, such as a computer-based game or virtual-reality environment. Simulation 108 may include one or more avatars 110, such as may represent human participants who interact with simulation 108.

A simulated purchase of an item on e-commerce web site 102 and on behalf of avatar 110 may be performed by providing e-commerce host 100 with an item selection together with simulated purchase information which preferably includes a simulated payment, as well as information identifying simulation 108 and avatar 110. The simulated payment may be in the form of fictitious credit card information that is known by e-commerce host 100 to be fictitious and/or known to be associated with simulation 108 and therefore fictitious. Alternatively, the payment may be simply flagged as being simulated, such as by checking a “Simulated Purchase” checkbox.

Once the simulated purchase has been made, e-commerce host 100 provides a description of the item whose purchase was simulated, along with information identifying avatar 110, to simulation host 106, preferably via a network 112, such as the Internet. The information may be provided using any protocol, including via electronic mail (email), to a destination known to e-commerce host 100 or provided together with the purchase information. The description of the item may include an image of the item and/or information that may be used to represent the item within simulation 108, such as color, dimensions, and/or other item characteristics. E-commerce host 100 associates the item with avatar 110 and preferably instantiates a simulation of the item within simulation 108, such as by displaying an image of the item. Thus, in the example shown in FIG. 1, a simulated purchase of ladies' shoes 104 may be made for avatar 110, whereupon a simulation of shoes 104 are displayed on the feet of avatar 110 within simulation 108. Simulation host 106 may also provide a simulation of the item as a user-interactive object, such as may be clicked-on and/or dragged using a mouse.

E-commerce host 100 may additionally facilitate the simulated purchase of an item by generating a shopping environment in accordance with an attribute value associated with avatar 110. For example, simulated physical measurements of avatar 110 may be provided to e-commerce host 100 which then provides a virtual dressing room and clothing suggestions that suit avatar 110's measurements.

E-commerce host 100 may be credited for simulated purchases with simulated currency, which may be exchanged for legal tender at an exchange rate.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

1.-6. (canceled)

7. A system for facilitating simulated purchases by virtual representations of participants in computer-based simulations of items outside of the context of computer-based simulations, the system comprising:
simulated payment information for an item for purchase, wherein said simulated payment is associated with a virtual representation of a participant in a computer-based simulation, wherein said item is available for purchase outside of the context of said simulation, and wherein said simulated payment is received outside of the context of said simulation;
a description of said item, wherein said description is provided subsequent to receiving said simulated payment, wherein and said description is provided in association with said virtual representation; and
a computer configured to store said description, receive said simulated payment, and provide said description to a process of said simulation.

8. The system according to claim 7 wherein said computer is operative to either of said receive said simulated payment and provide said description via a computer network.

9. The system according to claim 7 wherein said computer is operative to provide said description via email.

10. The system according to claim 7 wherein said computer is operative to receive an attribute value of said virtual representation and generate a shopping environment in accordance with said attribute value.

11. The system according to claim 7 wherein said computer is operative to determine that said simulated payment is associated with said virtual representation.

12. The system according to claim 7 wherein said computer is operative to receive simulated currency for said item, wherein said simulated currency is convertible to legal tender at an exchange rate.

13. A computer program embodied on a computer-readable medium, the computer program comprising:
a first code segment operative to receive a simulated payment for an item for purchase, wherein said simulated payment is associated with a virtual representation of a participant in a computer-based simulation, wherein said item is available for purchase outside of the context of said simulation, and wherein said simulated payment is received outside of the context of said simulation; and
a second code segment operative to provide a description of said item to a process of said simulation, wherein said description is provided subsequent to receiving said simulated payment, wherein and said description is provided in association with said virtual representation.
